(19) United States
(12) Patent Application Publication
(10) Pub. No.: US 2016/0039960 A1
(43) Pub. Date: Feb. 11, 2016

(54) REACTIVE RESIN COMPOSITION AND USE THEREOF

(71) Applicant: Hilti Aktiengesellschaft, Schaan (LI)

(72) Inventors: Armin Pfeil, Kaufering (DE); Memet-Emin Kumru, Augsburg (DE)

(21) Appl. No.: 14/920,595

(22) Filed: Oct. 22, 2015

Related U.S. Application Data
(63) Continuation of application No. PCT/EP2014/058065, filed on Apr. 22, 2014.

(30) Foreign Application Priority Data
Apr. 22, 2013 (EP) 13164652.3

(51) Int. Cl. C08F 222/20; E21D 20/02; C09K 8/575

(52) U.S. Cl. CPC C08F 222/20; C09K 8/5753; E21D 20/025

(57) ABSTRACT

A reactive resin composition is described, comprising a resin constituent (A) comprising a free-radically polymerizable compound (a-1), a compound (a-2) which can react with an amine, and a bridging compound (a-3) having at least two reactive functionalities, one of which can be free-radically (co)polymerize and one of which can be react with an amine, and a hardener constitute (H) comprising at least one dialkyl peroxide (h-1) and at least one amine (h-2) where the resin constituent (A) and the hardener (H) or the resin constituent (A) and at least one dialkyl peroxide (h-1) and at least one amine (h-2) of the hardener (H) are spatially separated from one another, in order to prevent reaction prior to mixing of these components, which is characterized in that the hardener constituent (H) further comprises an accelerator mixture (B) consisting of a copper compound (b-1) and a 1,3-dicarbonyl compound (b-2), with the proviso that the resin composition is suitable for use for construction purposes, preferably for securing anchor thread bars, iron reinforcements, bushing or screws in boreholes in all kinds of substrata.

### RELATED APPLICATIONS

This application claims priority to, and is a continuation of, co-pending International Application No. PCT/EP2014/058065 having an International filing date of Apr. 22, 2014, which is incorporated herein by reference, and which claims priority to European Patent Application No. 13164652.3, having a filing date of Apr. 22, 2013, which is also incorporated herein by reference in its entirety.

### FIELD OF THE INVENTION

The present invention concerns a reactive resin composition, particularly a cold setting reactive resin composition based on a radically hardenable compound and a compound, which can harden with an amine and also use thereof, particularly for chemical fastening of anchoring agents in boreholes.

### BACKGROUND OF THE INVENTION

The use of reactive resin mixtures on the basis of unsaturated polyester resins, vinyl ester resins or on the basis of epoxide resins as adhesive and bonding agents is known for a long time. This concerns two-component systems, in which one component contains the resin mixture and the other component contains the hardening agent. Other, usual components like filling agents, accelerators, stabilizers, solvents including reactive solvents (relative diluents) can be present in one and/or other components. By mixing both the components, the chemical reaction is initiated under formation of a hardened product.

Particularly for the chemical fastening technology e.g. plug sizes, there are higher requirements for the reactive resin masses as in this application, the mechanical strength, the adhesion on mineral bases and also on other bases like glass, steel and the similar, must be very good. A factor for the evaluation of the mechanical strength and adhesive properties is the so-called extraction test.

A lower extraction value, also called as load value indicates low tensile strength and low adhesion at the base. High load values must be obtained even under strict conditions in the use of reactive resin masses as organic binding agents for mortar and/or plug sizes, for instance at lower temperatures as is the case in winter or at high altitude; as well as at high temperatures as is the case in summer.

Basically, two systems are used in the chemical fastening technology. One system is on the basis of radically polymerizable, ethylenically unsaturated compounds, which are generally hardened with peroxides and the other system is based on epoxide-amine base. The first system is characterized by quick hardening, particularly at low temperatures like −10° C., shows however relatively high shrinkage and weaknesses in the load values. On the other hand, the epoxide-amine systems have slower hardening speed, particularly at lower temperatures below +5° C., however, they show considerably lesser shrinkage and are advantageous with respect to the load values.

In order to combine the advantages of both the systems, developments are continuously being made to develop dual hardening binding agents. This means such systems, whose hardening takes place both radically as well as by polyaddition. These are also called as hybrid systems or hybrid binding agents. These hybrid systems are based on the resin compositions, which contain hardenable compounds as per a first reaction type, for example, radically polymerizable compounds; and hardenable compounds as per a second reaction type that differs from the first reaction type, such as compounds, polymerizable compounds by polyaddition, for example, epoxides. A resin composition on the basis of radically polymerizable compound and an epoxide can harden, for example, with a peroxide and an amine, whereby the radical hardening reaction can be accelerated with a transition metal compound. However it was established that the low temperature properties in the hardening of reactive resin systems, which harden by addition of aliphatic amines and a peroxide to a hybrid compound that contains radically hardenable resin, selected under unsaturated polyesters or vinyl esters, and an epoxide resin, are bad.

EP 2357162 A1 describes a reactive resin composition on the basis of a system with a hybrid resin composition (hybrid binding agent), which contains radically hardenable resin and an epoxide resin and with a hardening agent, which contains aliphatic amine and a peroxide. The disadvantage of this reactive resin composition is that it cannot be stored stably, particularly as two component system, as peroxides are used as radical initiators.

In the article “Curing behavior of IPNS formed from model VERs and epoxy systems I amin cured epoxy”, K. Dean, W. D. Cook, M. D. Zipper, P. Burchill, Polymer 42(2001), 1345-1359, it has been described, amongst other things, that if Cumene hydroperoxide, Benzoyl peroxide or methyl ethyl ketone peroxide with or without cobalt octoate are used as radical initiators, then the peroxides decompose prematurely—for instance in storage—which has a negative effect on the radical hardening reaction. In addition to this, it has been described that hardening takes place only at increased temperatures i.e. only from +70° C. onwards, whereby similar initiator systems would not be suitable for compounds hardening at room temperature.

The inventors could confirm that a combination of perester as radical initiator with an amine as hardening agent is not storage stable for the epoxide resin. This is traced to the fact that the peresters react quickly with amines as a result of their reactive carbonyl group. However, the hydroperoxides formed by the aminolysis are unstable for the surplus of amines required for the hardening of epoxide resin, particularly they are not storage stable.

Accordingly, the reactive resin composition of EP 2357162 A1 cannot be packaged as a normal two component system, in which the resin components and the hardening agent components are reaction inhibiting and separate from each other.

The resin components, which are included in a first chamber, the radically hardenable compound, the compound hardenable with an amine, catalytic converters, accelerators, reactive diluents if necessary, inhibitors and a compound for bridging would be included in a two chamber system for a hybrid agent, as it is described in the EP 2357162 A1.

The hardener components that are integrated in a second chamber, would then contain both hardening agents, peroxide and amine. However, this leads to above mentioned problems.

A way to increase the storage stability of the described system could be to use less reactive peroxides as radical initiators like dialkyl peroxide. However, these peroxides have the major disadvantage that they decompose only at higher temperatures, as described above and the polymerization of the radically hardening resin constituent cannot take place in the conditions required for mortar applications or takes place with much delay. This again leads to insufficient hardening of the hybrid binding agent and correspondingly, to the insufficient properties of the hardened compound.

### BRIEF SUMMARY OF THE INVENTION

A reactive resin composition is described, comprising a resin constituent (A) comprising a free-radically polymerizable compound (a-1), a compound (a-2) which can react with an amine, and a bridging compound (a-3) having at least two reactive functionalities, one of which can be free-radically (co)polymerize and one of which can be react with an amine, and a hardener constitute (H) comprising at least one dialkyl peroxide (h-1) and at least one amine (h-2) where the resin constituent (A) and the hardener (H) or the resin constituent (A) and at least one dialkyl peroxide (h-1) and at least one amine (h-2) of the hardener (H) are spatially separated from one another, in order to prevent reaction prior to mixing of these components, which is characterized in that the hardener constituent (H) further comprises an accelerator mixture (B) consisting of a copper compound (b-1) and a 1,3-dicarbonyl compound (b-2), with the proviso that the resin composition is suitable for use for construction purposes, preferably for securing anchor thread bars, iron reinforcements, bushing or screws in boreholes in all kinds of substrata.

### BRIEF DESCRIPTION OF SEVERAL VIEWS OF THE DRAWINGS

[Not Applicable]

### DETAILED DESCRIPTION OF THE INVENTION

Thus, there is a need for a hybrid resin composition or a hybrid binding agent, which can be packaged as two component system and which is storage stable for months and which reliably hardens i.e. is cold setting at the normal application temperatures for reactive resin mortar i.e. between −10° C. and +60° C.

The objective of the invention is to prepare a hybrid resin composition, which does not have the above mentioned disadvantages of the system from the current state of the art, which is particularly cold setting and can be packaged as storage stable two component system.

The inventors have unexpectedly found out that this can be obtained by using dialkyl peroxides as radical initiator for the above described hybrid binding agent.

The following explanations of the terminology used here can be considered as useful for better understanding of the invention. In terms of the invention:
“Hybrid binding agent”, herein synonymously described also as “dual hardening binding agent”, a system, whose hardening takes place both radically as well as by polyaddition; these hybrid binding agents are based on resin compositions, which contain hardenable compounds as per a first reaction type, like radically polymerizable compounds and as per a second reaction type that differs from the first reaction type, hardenable compounds such as compounds that are compounds polymerizable by polyaddition, for example, epoxide.
“Cold setting” that the polymerization, herein also described also as “hardening” with the same meaning, of the both hardenable compounds at room temperature without additional energy input, for example, by heat supply by which the hardening agents in the reactive resin compositions can be started, if required, in presence of accelerators and also exhibit sufficient full hardening for the planned application purposes.
“monovalent”, “bivalent or polyvalent” in connection with the copper or vanadium compound, that it deals with compounds in which the copper or vanadium is present in the oxidation stage +I (monovalent), +II (bivalent) or higher (>+II; polyvalent);
“Oxidation resistant” in connection with copper(I) salts, that these are adequately stable against the atmospheric oxygen and do not oxidize to high-order copper compounds, especially under the compositions as per the invention, above all, inorganically filled compositions.
“Hardening agents”, which cause the polymerization (hardening) of the base resin;
“Aliphatic compound” an acyclic and cyclic, saturated or unsaturated hydrocarbon compound, which is non-aromatic (PAC, 1995, 67, 1307; Glossary of class names of organic compounds and reactivity intermediates based o structure (IUPAC Recommendations 1995));
“Polyamine”, a saturated, open-chain or cyclic organic compound, which is interrupted by the changing number of secondary amino groups (—NH—) and those that show primary amino groups (—NH₂) at the chain ends especially in the case of open-chain compounds;
“Accelerator” a compound capable of accelerating the polymerization reaction (hardening), which is used for accelerating the formation of a radical initiator.
“Polymerization inhibitor”, herein has the same meaning and is also called “Inhibitor”, a compound capable of inhibiting the polymerization (hardening), which is used to prevent the polymerization reaction and thus, an unwanted untimely polymerization of the radically polymerizable compound during the storage (often called as stabilizer) and which is used for delaying the start of the polymerization reaction directly after the addition of the hardener; in order to achieve the purpose of storage stability, the inhibitor is usually used in such small amounts that the gel time is not affected; in order to influence the point of time of the starting of the polymerization reaction, the inhibitor is usually used in such amounts that the gel time is influenced;
“Reactive diluent” liquid or low-viscosity monomers and base resins, which dilute other base resins or the resin constituent and thus, provide them with the viscosity necessary for their application, contain functional groups enabled for reaction with the base resin and which become component of the hardened mass (mortar) to a large extent at polymerization (hardening).
“Gel time” for unsaturated polyester or vinyl resins, which are usually hardened with peroxides, corresponds with the time of the hardening phase of the resin in the gel time in which the temperature of the resin increases from +25° C. to +35° C.; this corresponds more or less with the time period in which the fluidity or the viscosity of the resin is yet in such a range that the reactive resin or the reactive resin mass can be still processed or worked on easily;
“Two-component system” a system, which includes two components that are stored separately from each other, generally a resin component and a hardener component so that the resin components are hardened only after both the components are mixed;
“Multiple component system” a system, which covers three or more components stored separately so that the resin components are hardened only after all the components are mixed;
“(meth)acrylic . . . / . . . (meth)acrylic . . . ” that the ‘methacrylic . . . / . . . methacrylic . . . ” as also the “acrylic . . . / . . . acrylic . . . ” compounds must be included.

The advantage of dialkyl peroxides, namely their extraordinary stability, especially against amines, however, leads to the fact that a decomposition reaction for initialization of the radical polymerization of the unsaturated compound at room temperature is not expected. Hence it is necessary to activate the decomposition reaction in order to get a room temperature-hardening system as is required for the application in the field of chemical fastening technology.

The inventors have now found out, contrary to the popular opinion, that dialkyl peroxides can be activated by a combination of specific compounds so that it is possible to provide a dual-hardening reactive resin-composition, which hardens at room temperature and which is storage-stable, especially packaged as two-component system.

A first object of the invention is hence a reactive resin-composition, consisting of a resin constituent (A), which contains a compound (a-1) that can radically polymerize, a compound (a-2) that can react with an amine and a bridging compound (a-3) with at least two reactive functionalities, from which one can radically (co) polymerize and one can react with an amine and contains a hardener component (H), which contains at least one dialkyl peroxide (h-1) and at least one amine (h-2), whereby the resin constituent (A) and the hardening component (H) or the resin constituent (A) and at least one dialkyl peroxide (h-1) and at least one amine (h-2) of the hardener constituent (H) are spatially separated from each other in order to prevent a reaction prior to the mixing of these components, which is characterized in that the hardening constituent (H) further contains an accelerator mixture (B), which includes a copper compound (b-1) and a 1,3-dicarbonyl compound (b-2), with the proviso that the resin constituent (A) also contains a reduction agent (R), when the copper compound (b-1) bivalent or polyvalent.

The copper compound (b-1) is an appropriate bivalent or an oxidation-resistant monovalent copper salt, with the proviso that in case of bivalent copper salt, the reactive resin-composition further contains a reduction agent (R).

The actual activating copper salt is a monovalent copper salt (Cu(I)-salt). Due to the light oxidizability of the Cu (I) salts by atmospheric oxygen, the Cu (I) salt is formed in situ by a Cu (II) salt with a suitable reduction agent. Accordingly, the composition as per the invention preferably contains a Cu (II) carboxylate as Cu (II) salt. Suitable Cu (II) carboxylates are: Cu(II) octoate, Cu (II) naphthenate, Cu(II) acetate, Cu(II) trifluoroacetate, Cu(II) tartrate, Cu(II) gluconate, Cu(II) cyclohexanbutyrate, Cu(II) iso-butyrate. Basically, however, all Cu(II) salts are suitable, which dissolve well in the radically polymerizable compound and/or the reactive diluent, insofar as these are added.

Alternatively, it is possible to use oxidation-resistant Cu(I) salts such as 1,4-diazabicyclo[2.2.2]octane)copper(I) chloride complex (CuCl.DABCO complex) instead of a combination of a bivalent copper salt and a reduction agent.

All reduction agents, which are capable of reducing the bivalent copper salt to activating monovalent copper salt in situ, are suitable as reduction agents (R) for the reduction of the bivalent copper salt to monovalent copper salt. For example, metals such as Cu, Zn, Fe, ascorbic acid, ascorbate, ascorbic acid-6 palmitate or stearate, tin (II) salts, such as tin(II) octoate, catechol and its derivates, and iron(II) salts such as Borchi® OXY-Coat (company OMG Borchers) are mentioned.

A further constituent of the accelerator mixture (B) as per the invention is a 1,3-dicarbonyl compound (b-2), which is selected under compounds with the general formula (I)

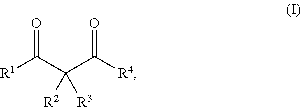

in which R¹ and R⁴ stand, irrespective of each other, for n-grade organic residue; R² and R³ stand, irrespective of each other, for hydrogen or an n-grade organic residue; or R² with R³ or R³ with R⁴ form a ring together, which include heteroatoms, where applicable, in or at the ring; or R¹ and R⁴ stand for —OR⁵ irrespective of each other, whereby R⁵ stands for a substituted alkyl, cycloalkyl, aryl or araklyl group, where applicable or R⁵ forms a ring together with R³, which shows further heteroatoms in or at the ring, where applicable.

An organic residue in which n bonds take place, is denoted as “n-grade organic residue” here and in the following. So, for example, alkyl, aryl, aralkyl, cycloalkyl, oxyalkyl residues are monovalent residues, methylene or phenylene are bivalent residues, whereas 1,2,3-butantriyl is a trivalent residue.

In a preferred embodiment, the compound of the formula (I) is a compound of the formula (II)

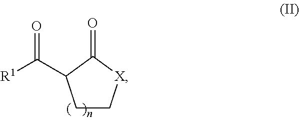

in which n stands for 1, 2 or 3, preferably for 1 or 2 and X stands for O, S or NR⁶, preferably for 0, wherein R⁶ stands for hydrogen and where applicable, for a substituted alkyl, cycloalkyl, aryl or aralkyl group.

In a specially preferred embodiment, n stands for 1, X for O and R¹ for OR⁷, wherein R⁷ stands for where applicable, a substituted alkyl group, especially preferred methyl group. Very specially preferred is the compound of the formula (II)α-acetylbutyrolactone (ABL).

In a preferred embodiment, the accelerator mixture (B) further includes a vanadium compound (b-3). By this, the hardening of the composition is improved again, which is reflected in a shorter gel time and better hardening through.

Salts of the quadrivalent or pentavalent vanadium (V(IV)-, V(V) salts) can be especially used as vanadium compound (b-3), whereby the pentavalent is preferred. Suitable vanadium salts are for example, vanadium (IV) oxide to (2,4-pendandionat) (product AB106355; company ABCR GmbH & Co. KG) or preferably the salt of an acidic phosphoric acid ester (product VPO0132, company OMG Borchers GmbH).

Ethylenically unsaturated compounds, compounds with carbon-carbon triple bonds and Thiol Yne/Ene resins, as known to the expert, are suitable as radically polymerizable compounds (a-1) as per the invention.

The group of ethylenically unsaturated compounds are preferred from these compounds, which include styrene and derivates, like (meth)acrylate, vinylester, unsaturated polyester, vinyl ether, allyl ether, itaconate, dicyclopentadiene-compounds and unsaturated fats, wherein unsaturated polyster resins and vinylester resins are particularly suitable and have been exemplarily described in the applications EP 1 935 860 A1, DE 195 31 649 A1, WO 02/051903 A1 and WO 10/108939 A1. Vinyl ester resins are the most preferred due to their hydrolytic resistance and excellent mechanical properties.

Examples of suitable unsaturated polyesters, which can be used in the resin composition according to the invention, are divided into the following categories as classified by M. Malik et al. in J. M. S.—Rev. Macromol. Chem. Phys., C40 (2 and 3), p. 139-165 (2000):

(1) Ortho resins: these are based on phthalic anhydride, maleic anhydride or fumaric acid and glycols, such as 1,2-propylene glycol, ethylene glycol, diethylene glycol, triethylene glycol, 1,3-propylene glycol, dipropylene glycol, tripropylene glycol, neopentyl glycol or hydrogenated bisphenol A;

(2) Iso resins: these are manufactured from isophthalic acid, maleic anhydride or fumaric acid and glycols. These resins can contain higher proportions of reactive diluents than the ortho resins;

(3) Bisphenol A-fumarates: these are based on ethoxylated bisphenol A and fumaric acid;

(4) HET-acid resins (hexachloroendomethylenetetrahydrophthalic acid resins): resins obtained from anhydrides or phenols containing chlorine/bromine in the manufacturing of unsaturated polyester resins.

In addition to these resin classes, the so-called dicyclopentadiene resins (DCPD resins) can be differentiated as unsaturated polyester resins as well. The class of DCPD resins is obtained either by modification of one of the above-named resin types via a Diels-Alder reaction with cyclopentadiene or, alternatively, by the first reaction of a dicarboxylic acid e.g. maleic acid, with dicyclopentadienyl, followed by a second reaction which is the usual manufacturing of an unsaturated polyester resin. The latter is referred to as a DCPD maleate resin.

The unsaturated polyester resin preferably has a molecular weight Mn in the range of 500 to 10,000 daltons, more preferably in the range of 500 to 5,000 and still more preferably in the range of 750 to 4,000 (in accordance with ISO 13885-1). The unsaturated polyester resin has an acid value in the range 0 to 80 mg KOH/g resin, preferably in the range of 5 to 70 mg KOH/g resin (in accordance with ISO 2114-2000). If a DCPD resin is used as the unsaturated polyester resin, the preferred acid value is 0 to 50 mg KOH/g resin.

In the sense of the invention, vinyl ester resins are oligomers, prepolymers or polymers with at least one (meth)acrylate end group, so-called (meth)acrylate-functionalized resins, which also include urethane (meth)acrylate resins and epoxy (meth)acrylates.

Vinyl ester resins that exhibit unsaturated groups only in end position are obtained, for example, by reacting epoxy oligomers or epoxy polymers (e.g. bisphenol A diglycidyl ether, phenol novolac type epoxy resins or epoxy oligomers based on tetrabromobisphenol A) with (meth)acrylic acid or (meth)acrylamide for instance. Preferred vinyl ester resins are (meth)acrylate-functionalized resins and resins obtained by reacting an epoxy oligomer or epoxy polymer with methacrylic acid or methacrylamide, preferably with methacrylic acid. Examples of such compounds are known from the applications U.S. Pat. No. 3,297,745 A, U.S. Pat. No. 3,772,404 A, U.S. Pat. No. 4,618,658 A, GB 2 217 722 A1, DE 37 44 390 A1 and DE 41 31 457 A1.

(Meth)acrylate-functionalized resins, which are obtained by reacting di- and/or higher functional isocyanates with suitable acrylic compounds for example, if necessary with the assistance of hydroxy compounds containing at least two hydroxyl groups as described for example in DE 3940309 A1, are particularly suitable and preferred as the vinyl ester resin.

Aliphatic (cyclic or linear) and/or aromatic di- or higher functional isocyanates, or prepolymers thereof, can be used as the isocyanates. The use of such compounds serves to increase the wettability, thus improving the adhesion properties. Aromatic di- or higher functional isocyanates or prepolymers thereof are preferred, whereby aromatic di- or higher-functional prepolymers are especially preferred. Toluene diisocyanate (TDI), diisocyanate diphenylmethane (MDI) and polymeric diisocyanate diphenylmethane (pMDI) to increase chain stiffening, and hexane diisocyanate (HDI) and isophorone diisocyanate (IPDI), which improve the flexibility, are examples that can be named. Most especially preferred from among these is polymeric diisocyanate diphenylmethane (pMDI).

Acrylic acid and acrylic acids substituted on the hydrocarbon radical, such as methacrylic acid, hydroxyl group-containing esters of acrylic or methacrylic acid with polyhydric alcohols, pentaerythritol tri(meth)acrylate, glycerol di(meth)acrylate, such as trimethylolpropane di(meth)acrylate and neopentyl glycol mono(meth)acrylate, are suitable as the acrylic compounds. Preferred are acrylic or methacrylic acid hydroxyl alkyl esters, such as hydroxyethyl (meth)acrylate, hydroxypropyl (meth)acrylate, polyoxyethylene (meth)acrylate, polyoxypropylene (meth)acrylate, in particular since these compounds serve to sterically hinder the saponification reaction.

Di- or higher hydric alcohols, for example derivatives of ethylene or propylene oxide, such as ethanediol, di- or triethylene glycol, propanediol, dipropylene glycol, other diols, such as 1,4-butanediol, 1,6-hexanediol, neopentyl glycol, diethanolamine, as well as bisphenol A or F or their ethoxylation/propoxylation and/or hydrogenation or halogenation products, higher hydric alcohols, such as glycerol, trimethylolpropane, hexanetriol and pentaerythritol, hydroxyl group-containing polyethers, for example oligomers of aliphatic or aromatic oxiranes and/or higher cyclic ethers, such as ethylene oxide, propylene oxide, styrene oxide and furan, polyethers which contain aromatic structural units in the main chain, such as those of bisphenol A or F, hydroxyl group-containing polyesters based on the above-mentioned alcohols or polyethers and dicarboxylic acids or their anhydrides, such as adipic acid, phthalic acid, tetra- or hexahydrophthalic acid, HET acid, maleic acid, fumaric acid, itaconic acid, sebacic acid and the like, are suitable as optionally usable hydroxy compounds. Hydroxy compounds with aromatic structural units to stiffen the resin chains, hydroxy compounds containing unsaturated structural units, such as fumaric acid, to increase the cross linking density, branched or star-shaped hydroxy compounds, especially tri- or higher hydric alcohols and/or polyethers or polyesters which contain their structural units, and branched or star-shaped urethane (meth)acrylates to achieve a lower viscosity of the resins or their solutions in reactive diluents and a higher reactivity and cross linking density, are particularly preferred.

The vinyl ester resin preferably has a molecular weight Mn in the range from 500 to 3,000 daltons, more preferably 500 to 1500 daltons (in accordance with ISO 13885-1). The vinyl ester resin has an acid value in the range of 0 to 50 mg KOH/g resin, preferably in the range of 0 to 30 mg KOH/g resin (in accordance with ISO 2114-2000).

To achieve lower acid numbers, hydroxyl numbers or anhydride numbers, for example, or to make the resins more flexible by incorporating flexible units into the basic framework, and the like, all these resins, which can be used according to the invention, can be modified in accordance with methods known to a skilled person.

The resin can also contain other reactive groups that can be polymerized with a radical initiator, such as peroxides; for example reactive groups derived from itaconic acid, citraconic acid and allylic groups, and the like.

A number of compounds, which on average contain more than one epoxy group, preferably two epoxy groups, per molecule and that are commercially available and known to a skilled person for this purpose, are suited for use as the epoxy resin (a-2). These epoxy compounds (epoxy resins) can be saturated or unsaturated, as well as aliphatic, alicyclic, aromatic or heterocyclic, and can also exhibit hydroxyl groups. They can also contain substituents that, under the mixing or reaction conditions, do not trigger interfering side reactions, for example alkyl or aryl substituents, ether groups and the like. Trimeric and tetrameric epoxies are also suitable within the scope of the invention. Suitable polyepoxy compounds are described in Lee, Neville, Handbook of Epoxy Resins, 1967, for example. The epoxies are preferably glycidyl ethers derived from polyhydric alcohols, in particular bisphenols and novolacs. The epoxy resins have an epoxy equivalent weight from 120 to 2,000 g/eq, preferably from 140 to 400. Mixtures of multiple epoxy resins can also be used. Particularly preferred are liquid diglycidyl ethers based on bisphenol A and/or F with an epoxy equivalent weight from 180 to 190 g/eq. Mixtures of multiple epoxy resins can also be used. The epoxy is preferably a diglycidyl ether of bisphenol A or of bisphenol F or a mixture thereof. In this context the “epoxy value” corresponds to the number of moles of epoxy groups in 100 g of resin (hereinafter also referred to as nEP). The epoxy equivalent weight (EEW) is calculated from this and corresponds to the reciprocal of the epoxy value. The commonly used unit is “g/val”

Examples of polyhydric phenols to be mentioned are: resorcinol, hydroquinone, 2,2-bis(4-hydroxyphenyl)propane (bisphenol A), isomer mixtures of dihydroxyphenyl methane (bisphenol F), tetrabromobisphenol A, novolacs, 4,4′-dihydroxyphenyl cyclohexane, 4,4′-dihydroxy-3,3′-dimethyldiphenylpropane, and the like.

The epoxy resin preferably has a molecular weight of at least 300 daltons. The epoxy resin has a molecular weight of at most 10,000 daltons, and preferably at most 5,000 daltons. The molecular weight of the epoxy resin substantially depends on the desired viscosity and reactivity of the reaction resin composition, and/or the cross linking density to be achieved.

According to the invention, combinations of different epoxy resins can also be used as the epoxy resin.

The resin component (A) of the reaction resin composition according to the invention includes the compound (a-1) and the compound (a-2) as two separate compounds, as well as a bridging compound (bridging agent) (a-3) that exhibits at least two reactive functional groups, of which one is capable of radically (co)polymerizing and one is capable of reacting with an amine. It has been found that the presence of such a bridging compound (a-3) leads to a further improvement of the low-temperature properties.

The bridging compound (a-3) preferably contains a radically curable functional group selected from among an acrylate, methacrylate, vinyl ether, vinyl ester and allyl ether group. Selecting the radically curable functional group of the bridging compound (a-3) from among an acrylate, methacrylate, vinyl ether, vinyl ester and allyl ether group is more preferred, whereby a methacrylate or acrylate group is more preferred and a methacrylate group is even more preferred.

The bridging compound (a-3) preferably contains an isocyanate, an epoxy or a cyclic carbonate as a functional group that can react with an amine, more preferably an epoxy and even more preferably a glycidyl ether. More preferably, the functional group of the bridging compound (a-3) that can react with an amine is selected from among an isocyanate, an epoxy, a cyclic carbonate, an acetoacetoxy and an oxalic acid-amide group; more preferred is an epoxy functionality and even more preferred is a glycidyl ether functionality.

In a preferred embodiment, the radically polymerizable functional group of the bridging compound is a methacrylate group, and the functional group that can react with an amine is an epoxy group.

The molecular weight Mn of the bridging compound is preferably less than 400 daltons, because this allows the low temperature properties to be improved even more, more preferably less than 350 daltons, even more preferably less than 300 daltons and even more preferably less than 250 daltons.

In a preferred embodiment, the reaction resin composition includes glycidyl methacrylate as the bridging compound (a-3). In a more preferred embodiment, the bridging compound (a-3) is a glycidyl methacrylate.

According to the invention, the curing of the radically curable compound is initiated with dialkyl peroxides (R₁—O—O—R₂) (h-1). “Dialkyl peroxide” in the sense of the invention means that the peroxo-group (—O—O—) is bonded to a carbon atom that is not part of an aromatic system, but can be attached to an aromatic system, such as a benzene ring.

Suitable dialkyl peroxides (h-1) are, for example, dicumyl peroxide, tert-butyl cumyl peroxide, 1,3- or 1,4-bis(tert-butylperoxyisopropyl)benzene, 2,5-dimethyl-2,5-di(tert-butylperoxyl) hexene (3), 2,5-dimethyl-2,5-di(tert-butylperoxyl) hexane, di-tert-butyl peroxide, whereby dicumyl peroxide is preferred. In this connection, we refer to GB 582,890 A1.

As such, the dialkyl peroxide (h-1) can be present in the form of a solid or as a liquid. It can also be present with a solvent as a solution, as an emulsion, as a suspension or as a paste. Particularly preferred is the dialkyl peroxide (h-1) in which the amine used as a curing agent for the compound (h-2) reacting with an amine is soluble.

The at least one amine (h-2) used for curing the epoxy resin (a-2) is expediently a primary and/or secondary amine. The amine can be aliphatic, including cycloaliphatic, aromatic and/or araliphatic, and carry one or more amino groups (hereinafter referred to as a polyamine). The polyamine preferably carries at least two primary aliphatic amino groups. In addition, the polyamine can also carry amino groups that have secondary or tertiary characteristics. Also, polyaminoamides and polyalkylene oxide-polyamines or amine adducts, such as amine-epoxy resin adducts or Mannich bases are likewise suitable. Amines are defined as araliphatic if they contain both aromatic and aliphatic radicals.

Without limiting the scope of the invention, examples of suitable amines are: 1,2-diaminoethane (ethylenediamine), 1,2-propanediamine, 1,3-propanediamine, 1,4-diaminobutane, 2,2-dimethyl-1,3-propanediamine (neopentanediamine), diethylaminopropylamine (DEAPA), 2-methyl-1,5-diaminopentane, 1,3-diaminopentane, 2,2,4- or 2,4,4-trimethyl-1,6-diaminohexane and mixtures thereof (TMD), 1-amino-3-aminomethyl-3,5,5-trimethylcyclohexane, 1,3-bis(aminomethyl)cyclohexane, 1,2-bis(aminomethyl)cyclohexane, hexamethylenediamine (HMD), 1,2- and 1,4-diaminocyclohexane (1,2-DACH and 1,4-DACH), bis(4-aminocyclohexyl)methane, bis(4-amino-3-methylcyclohexyl)methane, diethylenetriamine (DETA), 4-azaheptane-1,7-diamine, 1,11-diamino-3,6,9-trioxaundecane, 1,8-diamino-3,6-dioxaoctane, 1,5-diamino-methyl-3-azapentane, 1,10-diamino-4,7-dioxadecane, bis(3-aminopropyl)amine, 1,13-diamino-4,7,10-trioxatridecane, 4-aminomethyl-1,8-diaminooctane, 2-butyl-2-ethyl-1,5-diaminopentane, N,N-bis(3-aminopropyl)methylamine, triethylenetetramine (TETA), tetraethylenepentamine (TEPA), pentaethylenehexamine (PEHA), bis(4-amino-3-methylcyclohexyl)methane, 1,3-benzenedimethanamine (m-xylylenediamine, mXDA), 1,4-benzenedimethanamine (p-xylylenediamine, PXDA), 5-(aminomethyl)bicyclo[[2.2.1]hept-2-yl]methylamine (NBDA, norbornanediamine), dimethyldipropylenetriamine, dimethylaminopropyl-(aminopropyl)amine (DMAPAPA), 3-aminomethyl-3,5,5-trimethylcyclohexylamine (isophorone diamine (IPD)), diaminodicyclohexylmethane (PACM), mixed polycyclic amines (MPCA) (such as Ancamine® 2168), Dimethyl diaminodicyclohexylmethane (Laromin® C260), 2,2-bis(4-aminocyclohexyl)propane, (3(4),8(9)bis(aminomethyl)dicyclo[5.2.1.0^{2,6}]decane (isomer mixture, tricyclic primary amines; TCD-diamine).

Preferred are polyamines such as 2-methylpentanediamine (DYTEK A®), 1-amino-3-aminomethyl-3,5,5-trimethylcyclohexane (IPD), 1,3-benzenedimethanamine (m-xylylenediamine, mXDA), 1,4-benzenedimethanamine (p-xylylenediamine, PXDA), 1,6-diamino-2,2,4-trimethylhexane (TMD), diethylenetriamine (DETA), triethylenetetramine (TETA), tetraethylenepentamine (TEPA), pentaethylenehexamine (PEHA), N-ethyl amino piperazine (N-EAP), 1,3-bis-aminomethyl cyclohexane (1,3-BAC), (3(4),8(9)bis(aminomethyl)dicyclo[5.2.1.0^{2,6}]decane (isomer mixture, tricyclic primary amines; TCD-diamine), 1,14-diamino-4,11-dioxatetradecane, dipropylenetriamine, 2-methyl-1,5-pentanediamine, N,N′-dicyclohexyl-1,6-hexanediamine, N,N′-dimethyl-1,3-diaminopropane, N,N′-diethyl-1,3-diaminopropane, N,N-dimethyl-1,3-diaminopropane, secondary polyoxypropylene di- and triamines, 2,5-diamino-2,5-dimethylhexane, bis(aminomethyl)tricyclopentadiene, 1,8-diamino-p-menthane, bis(4-amino-3,5-dimethylcyclohexyl)methane, 1,3-bis(aminomethyl)cyclohexane (1,3-BAC), dipentylamine, N-2-(aminoethyl) piperazine (N-AEP), N-3-(aminopropyl) piperazine, piperazine.

In this context we refer to the application EP 1 674 495 A1, the content of which is herewith incorporated into this application.

The amine (h-2) can either be used alone, or as a mixture of two or more amines.

In a preferred embodiment of the invention, the composition contains other low-viscosity, radically polymerizable compounds as reactive diluents for the radically curable compound (a-1), so as to, if necessary, adjust its viscosity. These are expediently added to the radically curable compound (a-1).

Suitable reactive diluents are described in the applications EP 1 935 860 A1 and DE 195 31 649 A1. As a reactive diluent the resin mixture preferably contains a (meth)acrylic acid ester, whereby it is particularly preferred to select the (meth)acrylic acid esters from the group consisting of hydroxypropyl (meth)acrylate, propanediol-1,3-(meth)acrylate, butanediol-1,2-di(meth)acrylate, trimethylolpropane tri(meth)acrylate, 2-ethylhexyl (meth)acrylate, phenylethyl (meth)acrylate, tetrahydrofurfuryl (meth)acrylate, ethyl triglycol (meth)acrylate, N,N-dimethylaminoethyl (meth)acrylate, N,N-dimethylaminomethyl (meth)acrylate, butanediol-1,4-di(meth)acrylate, acetoacetoxyethyl (meth)acrylate, ethanediol-1,2-di(meth)acrylate, isobornyl (meth)acrylate, diethylene glycol di(meth)acrylate, methoxy polyethylene glycol mono(meth)acrylate, tri methylcyclohexyl (meth)acrylate, 2-hydroxyethyl(meth)acrylate, dicyclopentenyl oxyethyl (meth)acrylate and/or tricyclopentadienyl di(meth)acrylate, bisphenol A (meth)acrylate, novolac epoxy di(meth)acrylate, di-[(meth)acryloyl-maleoyl]-tricyclo-5.2.10.²⁶-decane, dicyclopentenyl oxyethyl crotonate, 3-(meth)acryloyl-oxymethyl-tricyclo-5.2.10.²⁶-decane, 3-(meth)cyclopentadienyl (meth)acrylate, isobornyl (meth)acrylate and decalyl-2-(meth)acrylate.

Other conventional radically polymerizable compounds can in principle also be used alone or in a mixture with the (meth)acrylic acid esters; e.g. styrene, a-methylstyrene, alkylated styrenes, such as tert-butylstyrene, divinylbenzene, and allyl compounds.

In a further preferred embodiment of the invention, the composition contains other epoxy-functionalized compounds as reactive diluents for the epoxy resin, so as to, if necessary, adjust its viscosity. These are expediently added to the epoxy resin (a-2).

Glycidyl ethers of aliphatic, alicyclic or aromatic mono- or in particular polyalcohols can be used as the reactive diluents. Examples are monogylcidylether, e.g. o-cresyl glycidyl ether, and/or in particular glycidyl ethers with an epoxy functionality of at least 2, such as 1,4-butanediol diglycidyl ether (BDDGE), cyclohexanedimethanol diglycidyl ether, hexanediol diglycidyl ether and/or in particular tri- or higher glycidyl ethers, e.g. glycerol triglycidyl ether, pentaerythritol tetraglycidyl ether or trimethylolpropane triglycidyl ether (TMPTGE), or also mixtures of two or more of these reactive diluents, preferably triglycidyl ether, particularly preferably as a mixture of 1,4-butanediol diglycidyl ether (BDDGE) and trimethylolpropane triglycidyl ether (TMPTGE).

The reaction of the epoxy resin (a-2) can be accelerated by the addition of suitable compounds. Such compounds are known to a skilled person. As an example, we refer to the novolac resins described in the application WO 99/29757 A1, which have proven to be particularly advantageous as accelerators. In this context we refer to the application WO 99/29757, the content of which is hereby incorporated into this application.

In a particularly preferred embodiment of the invention, the accelerator further comprises an aminophenol or an ether thereof, exhibiting at least one tertiary amino group, possibly with a primary and/or secondary amino group, as an accelerator. The accelerator is preferably selected from compounds with the general formula (III),

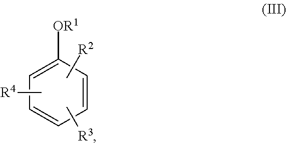

in which R¹ is hydrogen or a linear or branched C₁-C₁₅ alkyl radical, R² is (CH₂)ₙNR⁵R⁶—or NH(CH₂)ₙNR⁵R⁶, in which R⁵ and R⁶ independently of one another are a linear or branched C₁-C₁₅ alkyl radical and n=0 or 1, R³ and R⁴ independently of one another are hydrogen, (CH₂)ₙNR⁷R⁸ or NH(CH₂)ₙNR⁷R⁸, R⁷ and R⁸ independently of one another are hydrogen or a linear or branched C₁-C₁₅ alkyl radical and n=0 or 1.

R¹ is preferably hydrogen or a C₁-C₁₅ alkyl radical, in particular a linear C₁-C₁₅ alkyl radical, more preferably methyl or ethyl and most preferably methyl.

Preferably the phenol of the formula (I) is substituted in the 2, 4, and 6 positions, i.e. the substituents R², R³, and R⁴ are located in the 2, 4, and 6 position.

In the event that R⁵, R⁶, R⁷, and R⁸ represent alkyl moieties, they are preferably a C₁-C₅-alkyl moiety, more preferred methyl or ethyl, and most preferred methyl.

As an accelerant, either a compound or a mixture of at least two compounds of the formula (I) may be used.

Preferably the accelerant is selected from 2,4,6-tris(dimethyl amino methyl)phenol, bis(dimethyl amino methyl)phenol, and 2,4,6-tris(dimethyl amino)phenol. Most preferably the accelerant is 2,4,6-tris(dimethyl amino methyl)phenol.

Preferably the accelerant for the reaction of the epoxide resin (a-2) with an amine is separated from the epoxide resin in a reaction-inhibiting fashion.

The non-phenolic compounds commonly used as inhibitors for radically polymerizable compounds, such as stable radicals and/or phenothiazines, are suitable as inhibitors both for stable storage of the radically curable compound (a-1) and thus the resin component (A) as well as for adjusting the gel time, as known to one trained in the art. Phenolic inhibitors, as otherwise commonly used in radically curable resin compositions, cannot be used here, particularly when a bivalent copper salt is used as the accelerant, because the inhibitors react with the copper salt. This may have disadvantageous consequences for storage stability and gel time.

Preferably phenothiazines, such as phenothiazine and/or derivatives or combinations thereof, or stable organic radicals, such as galvinoxyl and N-oxyl-radicals may be used as non-phenolic or anaerobic inhibitors, i.e. inhibitors effective even without oxygen, contrary to phenolic inhibitors.

For example, those described in DE 199 56 509 A1 may be used as N-oxyl-radicals. Suitable stable N-oxyl-radicals (nitroxyl radicals) may be selected from 1-oxyl-2,2,6,6-tetramethyl piperidine, 1-oxyl-2,2,6,6-tetramethyl piperidine-4-ol (also called TEMPOL), 1-oxyl-2,2,6,6-tetramethyl piperidine-4-on (also called TEMPON), 1-oxyl-2,2,6,6-tetramethyl-4-carboxyl-piperidine (also called 4-carboxy-TEMPO), 1-oxyl-2,2,5,5-tetramethyl pyrrolidine, 1-oxyl-2,2,5,5-tetramethyl-3-carboxyl pyrrolidine (also called 3-carboxy-PROXYL), aluminum-N-nitrosophenyl hydroxylamine, diethyl hydroxylamine. Further suitable N-oxyl compounds include oximes, such as acetaldoximes, acetonoxime, methyl ethyl ketoxime, salicyl oxime, benzoxime, glyoxime, dimethyl glyoxime, acetone-O-(benzyloxy carbonyl)oxime, or indolin-nitroxide radicals, such as 2,3-dihydro-2,2-diphenyl-3-(phenylimino)-1H-indol-1-oxylnitroxide, or β-phosphorylated nitroxide radicals, such as 1-(diethoxy phosphinyl)-2,2-dimethyl propyl-1,1-dimethyl methyl-nitroxide, and the like.

Further, in the para-position in reference to the hydroxyl group, substituted pyrimidinol or pyridinol compounds may be used as inhibitors, as described in the not pre-published patent document DE 10 2011 077 248 B1.

The inhibitors may be used, depending on the desired features of the resin compositions, either alone or in combination of two or more thereof. The combination of phenolic and non-phenolic inhibitors allows here a synergistic effect, as well as the adjustment of an essentially drift-free setting of the gel time of the formulation of the reaction resin.

Beneficially, the inhibitors are added to the resin component (A).

In one embodiment the reaction resin-composition may additionally include an adhesive. By the use of the adhesive the interlacing of the wall of the bore hole and the dowel mass is improved, so that the adhesion also increases in the cured state. This is important for the use of two-component dowel mass, e.g., in diamond-drilled bore holes, and increases load values. Suitable adhesives may be selected from the group of the silanes, which are functionalized with additional reactive, organic groups, and can be embedded in the polymer network, such as 3-glycidoxypropyl trimethoxy silane, 3-glycidoxy propyl triethoxy silane, 2-(3,4-epoxy cyclohexyl)ethyl trimethoxy silane, N-2-(amino ethyl)-3-amino propyl methyl diethoxy silane, N-2-(amino ethyl)-3-amino propyl triethoxy silane, 3-amino propyl trimethoxy silane, 3-amino propyl triethoxy silane, N-phenyl-3-amino ethyl-3-amino propyl trimethoxy silane, 3-mercapto propyl trimethoxy silane, and 3-mercapto propyl methyl dimethoxy silane, with 3-amino propyl triethoxy silane being preferred. To this regards, reference is made to the applications DE200910059210 and DE201010015981, with their content hereby being included in the application.

The composition of the reaction resin may further include inorganic aggregates, such as fillers and/or other additives, with the aggregates potentially being added to the resin component (A) and/or the curing agent (H).

Common fillers, preferably mineral or mineral-like fillers, such as quartz, glass, sand, quartz sand, quartz meal, porcelain, corundum, ceramic, talcum, silicic acid (e.g., pyrogenic silicic acid), silicates, clay, titanium dioxide, chalk, heavy spar, feldspar, basalt, aluminum hydroxide, granite, or sandstone may be used as fillers, and polymer fillers, such as thermosets, hydraulically curable fillers, such as gypsum, caustic lime, or cement (e.g., clay cement or Portland cement), metals, such as aluminum, soot, further wood, mineral or organic fibers, or the like, or mixtures of two or more thereof, which may be added in the form of powers, granularly, or in the form of formed bodies. The fillers may be present in any arbitrary form, for example as powder or meal, or as formed bodies, such as cylindrical, annular, spherical, platelet, rod-shaped, saddle, or crystalline form, of further in a fibrous form (fibrous fillers) and the respective basic parts preferably show a maximum diameter of 10 mm. Preferred and with considerable reinforcing effect are however the globular inert substances (spherical form).

Other potential additives are further thixotropic means, such as perhaps organically post-processed pyrogenic silicic acid, bentonite, alkyl or methyl cellulose, castor oil derivatives, or the like, plasticizers, such as phthalic acid ester or sebacinic acid ester, stabilizers, anti-static means, thickeners, flexibility agents, curing catalysts, rheology agents, wetting agents, colorants, such as dyes or particularly pigments, for example for a different coloring of the components for a better control of the mixing thereof or the like, or mixtures of two or more. Non-reactive diluting agents may also be present (solvents), such as low-alkyl ketones, e.g., acetone, di-low alkyl low alkanoylamides, such as dimethyl acetamide, low-alkyl benzenes, such as xylenes or toluene, phthalic acid ester or paraffin, water, or glycols. Further, metal scavengers may be present in the reaction resin composition in the form of surface-modified pyrogenic silicic acids.

To this regard, reference is made to the applications WO 02/079341 and WO02/079293, as well as WO 2011/128061 A1, with their content hereby being included in the application.

According to the invention the components of the reaction resin composition are arranged spatially such that the resin component (A), which can radically cure the composition (a-1) and the compound, which can cure with an amine (a-2), the dialkyl peroxide (h-1), and the amine (h-2) are present separated from each other.

In this embodiment of the invention the reaction resin composition is present as a two-component system. Here it is beneficial if the mixture of accelerants (B) is stored together with the dialkyl peroxide (h-1) and the amine (h-2) in one component, the curing component. Accordingly the resin component is provided together with the reactive solvent or solvents, the inhibitor, and the reduction means, if these components are added, in another component, the resin component. This way it is prevented, on the one hand, that the curing of the resin component already begins during storage.

According to a preferred embodiment of the invention the reaction resin composition is contained in a cartridge, a package, a capsule, or a film bag, comprising two or more chambers, which are separated from each other and in which the resin component and the curing component or the resin component and at least one dialkyl peroxide and/or at least one amine are contained separated from each other in a reaction-inhibiting fashion.

The reaction resin composition according to the invention is primarily used in the construction sector, for example for repairing concrete, as polymer concrete, as a coating mass on the basis of artificial resin, or as a cold-curing road marking means. It is particularly suitable for the chemical fastening of anchoring elements, such as anchors, reinforcement rods, screws, and the like in bore holes, particularly in bore holes in various undergrounds, particularly mineral undergrounds, such as based on concrete, aerated concrete, brickwork, calcareous sandstone, sandstone, natural stone, or the like.

Another object of the invention is the use of the reaction resin composition as a binder, particularly for fastening anchoring means in bore holes of various undergrounds and for constructive adhesion.

The present invention also relates to the use of the above-defined reaction resin composition for construction purposes, comprising the curing of the composition by way of mixing the resin component (A) with the curing component (H) or the resin component (A) with at least one peroxide (B) and at last one amine (C) of the curing component (H).

More preferred, the reaction resin composition according to the invention is used for fastening threaded anchoring rods, reinforcement irons, threaded sheaths, and screws in bore holes in different undergrounds, comprising the mixing of the resin component (A) with the curing component (H) or the resin component (A) with at least one peroxide (B) and at least one amine (C) of the curing component (H), inserting the mixture into the bore hole, inserting the threaded anchor rods, the reinforcement irons, the threaded sheaths, and the screws into the mixture in the bore hole, and curing the mixture.

The reaction resin composition according to the invention is preferably cured at a temperature ranging from −20 to +200° C., preferably ranging from −20 to +100° C., and most preferred ranging from −10 to +60° C. (so-called cold curing).

The invention is explained in greater detail based on a number of examples and reference examples. All examples support the scope of the claims. The invention is however not limited to the specific embodiments shown in the examples.

### EXEMPLARY EMBODIMENTS

### Examples 1 to 7

A resin component was produced by agitating 19.38 g of a bisphenol A glycerolate dimethacrylate, 51.61 g of a bisphenol A-diglycidyl ether, 12.85 (sic) 1.4-butandiol dimethacrylate, 16.16 (sic) glycidyl methacrylate, 0.04 g 4-hydroxy-2,2,6,6-tetramethyl piperidine-N-oxyl, and 65 ppm methyl hydroquinone into a homogenous solution. The accelerants are added to this resin mixture at +60° C. in the quantities listed at table 1.

For the component of the curing agent 4.06 g dicumyl peroxide is homogenously dissolved in 13.28 (sic) 1,5-diamino-2-methyl pentane. This solution was added to the resin component at +25° C., homogenized, and the gel time (t(25->80° C.)) as well as the time until reaching the maximum temperature (T(25->T(max)) were determined.

The determination of the gel times occurs with a conventional device (GELNORM®-gel timer) at a temperature of 25° C. For this purpose, the components are mixed and immediately after the mixing process tempered to 25° C. in a silicon bath, and the temperature of the sample was measured. The sample itself is here present in a test tube, which is placed into an air jacket, immersed in a silicon bath, for the purpose of tempering.

The temperature of the sample is applied in reference to time. The evaluation occurs according to DIN16945, page 1, and DIN 16916. The gel time is the time at which a temperature increase is reached from 25° C. to 80° C. (t(25->80° C.).

The results of the gel time determination are listed in table 1.

From table 1 it is discernible that the reaction resin compositions according to the invention show gel times from 25 to 78 minutes and were also completely cured within approximately 30 to 85 minutes. The maximum temperatures (T(max)) determined allow the conclusion that both the epoxy amine portion as well as the radically curable portion did set.

This leads to good mechanic features and thus to a suitability as binders for inorganically filled reaction resin compositions.

### Reference Examples

As a reference, in the compositions according to examples 1 to 7 the accelerants and the reduction means were omitted. Here, it was observed that the gel times t (25->80° C.) increased to considerably more than 90 minutes and the maximum temperatures dropped considerably below 100° C. This leads to insufficient mechanic features (“soft polymers”) and indicates that here only the epoxy-amine portion cured, while the radical polymerization occurred only insufficiently or not at all.

TABLE 1
Composition of the accelerant mixture, gel times, and maximum temperatures

| Example | | 1 | 2 | 3 | 4 | 5 | 6 | 7 |
|---|---|---|---|---|---|---|---|---|
| Resin | | | | | 100 | | | |
| Accelerant 1 (b-1) | Cu(II)octoate | | 1.00 | 1.00 | 2.50 | 1.00 | 1.00 | |
| | TIB-KAT808¹⁾ | | | | | | | 1.00 |
| | CuCl⊙DABCO²⁾ | 1.00 | | | | | | |
| Accelerant 2 (b-2) | AAEMA³⁾ | 5.00 | 5.00 | | 5.00 | 5.00 | 5.00 | 5.00 |
| | ABL⁴⁾ | | 5.00 | 5.00 | | | | |
| Accelerant 3 (b-3) | VP0132⁵⁾ | 1.00 | 1.00 | 1.00 | 2.50 | 1.00 | | |
| | AB106355⁶⁾ | | | | | | 1.00 | |
| t (25 −> 80° C.) | min | 33 | 25 | 34 | 38 | 49 | 78 | 75 |
| t (25 −> T(max)) | min | 38 | 29 | 36 | 41 | 56 | 85 | 80 |
| T (max) | ° C. | 175 | 155 | 170 | 160 | 151 | 114 | 135 |

¹⁾Solution of Cu(II)naphthenate in white spirits (Co. TIB Chemicals AG)
²⁾CuCl⊙ 1,4-diazabicyclo(2,2,2)octane (Co. Sigma Aldrich)
³⁾2-(acetoacetoxy)ethyl methacrylate
⁴⁾α-acetyl butyrolactone
⁵⁾vanadium(V)salt of an acidic phosphoric acid ester, dissolved (Co. OMG Borchers GmbH)
⁶⁾vanadium(IV)oxide-bis(2,4-pentandionate) (Co. ABCR GmbH & Co. KG)

1. A reaction resin composition, comprising
a resin component (A), which may comprise a compound (a-1) potentially polymerizing radically, a compound (a-2), which can react with an amine, and a bridged compound (a-3) with at least two reactive functionalities, with one being able to radically (co)polymerize and one potentially reacting with an amine, and
a curing agent (H), which comprises at least one dialkyl peroxide (h-1) and at least one amine (h-2),
with the resin component (A) and the curing component (H) or the resin component (A) and at least one dialkyl peroxide (h-1) and at least one amine (h-2) of the curing component (H) being spatially separated from each other, in order to prevent any reaction prior to mixing these components,
characterized in that the curing component (H) further comprises an accelerant mixture (B), which includes a copper compound (b-1) and a 1,3-dicarbonyl compound (b-2), conditional to the resin component (A) further comprising a reduction means (R) when the copper compound (b-1) is bivalent or polyvalent.

2. A reaction resin composition according to claim 1, characterized in that the reduction means (R) is selected from a group comprising metals, selected from Cu, Zn, and Fe, ascorbic acid, ascorbates, ascorbinic acid-6-palmitate, ascorbinic acid-6-stearate, tin(II)-salts, pyrocatechol, and derivatives thereof, hydroquinone, or perhaps substituted derivatives thereof, and iron(II) salts.

3. A reaction resin composition according to claim 1, characterized in that the copper compound (b-1) is a bivalent or an oxidation-stable monovalent copper salt.

4. A reaction resin composition according to claim 3, characterized in that the copper compound (b-1) is a copper(II)carboxylate.

5. A reaction resin composition according to claim 1, characterized in that the 1,3-dicarbonyl compound (b-2) is a compound with the general formula (I) 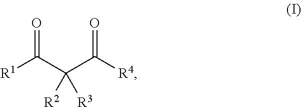
in which
R¹ and R⁴ independent from each other represent a n-valent organic moiety;
R² and R³ independent from each other represent hydrogen or a n-valent organic moiety,
or R² with R³ or R³ with R⁴ together form a ring, which perhaps comprises hetero-atoms in or at the ring;
or R¹ and R⁴ independent from each other represent —OR⁵, with R⁶ representing a perhaps substituted alkyl, cycloalkyl, aryl, or aralkyl group, or R⁵ together with R³ forming a ring, which perhaps shows additional heteroatoms in or at the ring.

6. A reaction resin composition according to claim 1, characterized in that the accelerant mixture (B) further comprises a vanadium compound (b-3).

7. A reaction resin composition according to claim 6, characterized in that the vanadium compound (b-3) is a vanadium(IV) or a vanadium(V) compound.

8. A reaction resin composition according to claim 1, characterized in that the compound (a-1), which can radically polymerize, is an unsaturated polyester resin, a vinyl ester resin, and/or a vinyl ester-urethane resin.

9. A reaction resin composition according to claim 1, characterized in that the compound (a-2) which can react with an amine is an epoxide functionalized resin.

10. A reaction resin composition according to claim 1, characterized in that the bridging compound (a-3) comprises a radically curable functionality, selected from an acrylate, methacrylate, vinyl ether, vinyl ester, and allyl ether functionality, and a functionality, which can react with an amine, selected under an isocyanate, epoxide, cyclic carbonate, acetoacetoxy, and oxalic acidamide functionality.

11. A reaction resin composition according to claim 10, characterized in that the functionality of the bridging compound (a-3), which may be radically (co)polymerized, is a methacrylate functionality and the functionality reacting with an amine is an epoxide functionality.

12. A reaction resin composition according to claim 1, characterized in that the dialkyl peroxide (h-1) is selected from a group comprising dicumyl peroxide, tert-butylcumyl peroxide, 1,3- or 1,4-bis(tert-butyl peroxy isopropyl)benzene, 2,5-di methyl-2,5-di(tert-butyl peroxyl)hexin(3), 2,5-di methyl-2,5-di(tert-butyl peroxyl)hexane, and di-tert-butyl peroxide.

13. A reaction resin composition according to claim 1, characterized in that the amine (h-2) is selected from a group comprising aliphatic amines, preferably primary and/or secondary aliphatic amines, aliphatic and araliphatic polyamines.

14. A reaction resin composition according to claim 1, characterized in that the composition further comprises a non-phenolic inhibitor (I).

15. A reaction resin composition according to claim 14, characterized in that the non-phenolic inhibitor (I) is a stabile N-oxyl-radical.

16. A reaction resin composition according to claim 1, characterized in that the resin component (A) further comprises a reactive diluent.

17. A reaction resin composition according to claim 16, characterized in that at least a portion of the reactive diluent can react radially (co)polymerizing and/or react with an amine.

18. A reaction resin composition according to claim 1, characterized in that the resin component (A) and/or the curing component (H) comprise at least one inorganic filler, which is selected from a group comprising quartz, glass, corundum, porcelain, ceramics, light spar, heavy spar, gypsum, talcum, chalk, or mixtures thereof, with these fillers being included in the form of sands, meals, or formed bodies, particularly in the form of fibers or spheres.

19. A reaction resin composition according to claim 1, characterized in that they are contained in a cartridge, a package, a capsule, or a film bag comprising two or more chambers, which are separated from each other and in which the resin component (A) and the curing component (H) or the resin component (A) and at least one dialkyl peroxide (h-1) and at least one amine (h-2) of the curing agent (H) are contained separated from each other, in order to prevent any reaction.

20. The use of a reaction resin composition for construction purposes comprising
a resin component (A), which may comprise a compound (a-1) potentially polymerizing radically, a compound (a-2), which can react with an amine, and a bridged compound (a-3) with at least two reactive functionalities, with one being able to radically (co)polymerize and one potentially reacting with an amine, and
a curing agent (H), which comprises at least one dialkyl peroxide (h-1) and at least one amine (h-2),
with the resin component (A) and the curing component (H) or the resin component (A) and at least one dialkyl peroxide (h-1) and at least one amine (h-2) of the curing component (H) being spatially separated from each other, in order to prevent any reaction prior to mixing these components,
characterized in that the curing component (H) further comprises an accelerant mixture (B), which includes a copper compound (b-1) and a 1,3-dicarbonyl compound (b-2), conditional to the resin component (A) further comprising a reduction means (R) when the copper compound (b-1) is bivalent or polyvalent.
wherein the curing of the composition is by way of mixing the resin components (A) with the curing agent (H) or the resin component (A) with at least one dialkyl peroxide (h-1) and at least one amine (h-2) of the curing component (H).

21. The use according to claim 20 for fastening threaded anchor rods, reinforcement irons, threaded sheaths, or screws in bore holes in arbitrary undergrounds, comprising the mixing of the resin component (A) with a curing component (H) or the resin component (A) with at least one dialkyl peroxide (h-1) and at least one amine (h-2) of the curing component (H); the insertion of this mixture into the bore hole; the insertion of the threaded anchor rods, reinforcement irons, threaded sheaths, or screws into the mixture, and the curing of this mixture.

22. The use according to claim 20, characterized in that the curing occurs at a temperature ranging from −20 to +200° C., preferably from −20 to +100° C., and most preferred ranging from −10 to +60° C.

23. Cured structural objects obtained by curing the reaction resin composition comprising
a resin component (A), which may comprise a compound (a-1) potentially polymerizing radically, a compound (a-2), which can react with an amine, and a bridged compound (a-3) with at least two reactive functionalities, with one being able to radically (co)polymerize and one potentially reacting with an amine, and
a curing agent (H), which comprises at least one dialkyl peroxide (h-1) and at least one amine (h-2),
with the resin component (A) and the curing component (H) or the resin component (A) and at least one dialkyl peroxide (h-1) and at least one amine (h-2) of the curing component (H) being spatially separated from each other, in order to prevent any reaction prior to mixing these components,
characterized in that the curing component (H) further comprises an accelerant mixture (B), which includes a copper compound (b-1) and a 1,3-dicarbonyl compound (b-2), conditional to the resin component (A) further comprising a reduction means (R) when the copper compound (b-1) is bivalent or polyvalent.
